(19) United States
(12) Patent Application Publication
(10) Pub. No.: US 2009/0162820 A1
(43) Pub. Date: Jun. 25, 2009

(54) Educational Simulator for Trasesophageal Echocardiography

(75) Inventors: Fukuji Tada, Mitaka-city (JP); Hiroshi Nagai, Mitaka-city (JP); Yoshiyuki Fukushima, Mitaka-city (JP)

Correspondence Address: POSZ LAW GROUP, PLC, 12040 SOUTH LAKES DRIVE, SUITE 101, RESTON, VA, 20191, US

(73) Assignee: HRS Consultant Service, Inc., Mitaka-city, Tokyo-pref. (JP)

(21) Appl. No.: 11/992,654

(22) PCT Filed: Feb. 16, 2007
(86) PCT No.: PCT/JP2007/052810

§ 371 Date: Mar. 27, 2008

(30) Foreign Application Priority Data
Feb. 24, 2006 (JP) 2006-047616

(51) Int. Cl. G09B 23/30

(52) U.S. Cl. 434/272

(57) ABSTRACT

An educational simulator for transesophageal echocardiography device, which includes a human phantom patterned after a human upper body having a neck, an esophagus and a stomach which communicate with each other, and a heart, a dummy probe which is patterned after a genuine ultrasonic probe and of which the tip is embedded with a magnet, a sensor which detects the insertion length and rotation angle of the dummy probe and is placed in the said neck, magnetic sensors which sense the magnetism of the said magnet, a three-dimensional image data archive which stores three-dimensional image data of echocardiography, a CPU which calculates the position, inclination and direction of the dummy probe on the basis of information from each said sensor and clips tomographic image data from the three-dimensional image data on the basis of the calculation, and a display section which shows the clipped tomographic image data as two-dimensional images.

### CROSS-REFERENCE TO RELATED APPLICATION

This application is a U.S. national stage application of PCT/JP2007/052810 filed on Feb. 16, 2007, which is based on Japanese Patent Application No. 2006-047616 filed on Feb. 24, 2006, the disclosures of which are incorporated herein by reference.

### FIELD OF THE INVENTION

The present invention relates to an educational simulator for learning transesophageal echocardiography.

### BACKGROUND OF THE INVENTION

Generally, it is very important to obtain high-quality echo records in ultrasonic diagnosis. It is understood that a lot of training and experience is required until a physician can obtain high-quality echo records by manipulating an ultrasonic diagnostic apparatus.

For ultrasonic diagnosis in a heart (hereinafter called ‘echocardiography’), there are available two methods, one of which is called ‘transthoracic echocardiography’ in which echo images are taken while an ultrasonic probe is applied to a chest surface. The other method is called ‘transesophageal echocardiography’ in which echo images are taken while the ultrasonic probe is inserted into an esophagus and stomach in a body.

In the transthoracic echocardiography, echocardiographic records can be obtained only at a limited prescribed place away from ribs and lungs, since the heart is surrounded with the ribs and lungs, and also it is difficult to obtain high-quality echocardiographic records because of diagnosis through a thick skin. Meanwhile, the transesophageal echocardiography enables high-quality echo records to be acquired since the esophagus and stomach are close to the heart so that the ribs and lungs do not interfere. It is also possible to use the transesophageal echocardiography for monitoring the heart during cardiac surgery or in an intensive care unit after the cardiac surgery. The transesophageal echocardiography has been used in many hospitals and so on because of several advantages over the transthoracic echocardiography.

In the meantime, it is necessary to manipulate the ultrasonic probe three-dimensionally to acquire the echocardiographic records either in the transthoracic echocardiography or in the transesophageal echocardiography. But, the transesophageal echocardiography has difficulty of manipulating the ultrasonic probe inserted into the body, unlike the transthoracic echocardiography. Further, the transesophageal ultrasonic diagnostic apparatus is more costly than the transthoracic ultrasonic diagnostic apparatus. The advent of an inexpensive simulator for educational use is awaited, instead of the transesophageal ultrasonic diagnostic apparatus.

The applicant of this patent application has previously filed a patent application on an invention of an educational simulator to be substituted for the transthoracic ultrasonic diagnostic apparatus. (Patent Application 2005-371816). The invention described in Patent Application 2005-371816 is titled ‘Educational Simulator for Transthoracic Echocardiography’ which is an ultrasonic diagnostic simulator targeting the heart. The object of the invention is to provide an educational simulator for transthoracic echocardiography which runs simulations in a feeling like actual ultrasonic diagnosis. To attain the object, the educational simulator for transthoracic echocardiography is composed of a chest phantom in which position sensors are embedded at prescribed positions beneath the chest surface, a dummy probe incorporating a magnet and equipped with a pressure sensor comprising at least three force resistor sensors at the acral part, a three-dimensional image data archive which stores echocardiographic three-dimensional image data, a central processing unit (CPU) which calculates the position, inclination and pressing force of the dummy probe on the basis of information from each said sensor and clips two-dimensional image data from the three-dimensional data on the basis of the calculation, and a display section which shows the said clipped two-dimensional image data as two-dimensional images.

The educational simulator according to Patent Application 2005-371816, however, relates to transthoracic echocardiography, and the dummy probe is patterned after an ultrasonic probe used in the transthoracic echocardiography. This educational simulator for transthoracic echocardiography as is cannot be used as an educational simulator for transesophageal echocardiography.

### SUMMARY OF THE INVENTION

The object of this invention, therefore, is to provide an educational simulator for transesophageal echocardiography which can run simulations in a feeling similar to actual ultrasonic diagnosis.

To attain the said object, the educational simulator for transesophageal echocardiography according to a first embodiment of this patent application comprises:
a human phantom set in a chassis patterned after a human upper body, wherein a neck communicating with the outside through a palate, an esophagus communicating with the neck and a stomach communicating with the esophagus are fixed at prescribed positions;
a dummy probe patterned after a genuine esophageal ultrasonic probe and comprising a sheath-shaped acral portion having a nearly spherical tip, a bending portion which is free to curve and communicates with the said acral portion, a flexural tube portion which is flexible and communicates with the said bending portion, and a manipulating portion which communicates with the said flexural tube portion and is provided with a changeover switch for changing over the tomographic direction of an artificial heart together with a manipulating knob for controlling the curving direction of the said bending portion;
an insertion length sensor which detects the insertion length from the said neck of the said dummy probe placed in the said neck and inserted into the said esophagus, and a rotation angle sensor which detects the rotation angle of the said flexural tube in the said neck;
a position sensor which detects the position of the tip of the said dummy probe;
a bending angle sensor which detects the bending angle of the said bending portion;
a three-dimensional image data archive which stores the three-dimensional image data of transesophageal echocardiography;
a CPU which calculates the position and inclination of the acral portion of the said dummy probe in relation to the artificial heart in the said human phantom from the information on the said insertion length, the information on the said rotation angle, the information on the said position of the tip and the information on the said bending angle and which clips tomographic image data out of the said three-dimensional image data, after calculating the position, inclination and direction of the tomographic view of the three-dimensional images to the said three-dimensional image data on the basis of the results of the said calculation and the tomographic directional information on the said artificial heart; and
a display section which shows the said clipped tomographic image data as two-dimensional images.

Further, the educational simulator for transesophageal echocardiography according to a second embodiment of this patent application is the educational simulator for transesophageal echocardiography defined in the first embodiment, wherein the said echocardiographic three-dimensional image data are echocardiographic three-dimensional real image data and/or echocardiographic three-dimensional virtual image data, and the said two-dimensional images shown on the said display section are two-dimensional images based on the said three-dimensional real image data and/or the said three-dimensional virtual image data, or three-dimensional image data in which the said three-dimensional real image data and the said three-dimensional virtual image data are superimposed. The said display section shows the heart as if it pulsates continuously, by repeatedly showing time-series data on one or several beats of the heart.

Also, the educational simulator for transesophageal echocardiography according to a third embodiment of this patent application is the educational simulator for transesophageal echocardiography defined in the first embodiment, wherein the said human phantom is equipped with a heart which is fixed to a prescribed position in the said chassis, and the said chassis, said palate, said neck, said esophagus, said stomach and said heart connecting with diverse blood vessels are formed of transparent or translucent materials.

Further, the educational simulator for transesophageal echocardiography according to a fourth embodiment of this patent application is the educational simulator for transesophageal echocardiography defined in the third embodiment, wherein the said palate, said neck and said esophagus are formed of flexible materials.

Also, the educational simulator for transesophageal echocardiography according to a fifth embodiment is the educational simulator for transesophageal echocardiography defined in the first embodiment of this patent application, wherein the said insertion length sensor and said rotation angle sensor comprise a light emitting element, and a light receiving element which receives the reflected light on the surface of the said dummy probe of the light emitted from the said light emitting element and the insertion length and rotation angle of the said dummy probe are detected according to variation in the pattern of the surface of the said dummy probe sensed by the said light receiving element, and wherein the said position sensor comprises a magnet embedded in the said acral portion, and magnetic sensors fixed to the respective portions on the outside of the said esophagus and said stomach, and the position of the tip of the said acral portion is detected by the magnetic sensors sensing magnetism of the said magnet, and wherein the said bending angle sensor comprises two wire ropes inserted into the said dummy probe, with one end of the said wire ropes fixed to the tip of the said bending portion and with the other end of the said wire ropes extended to the inside of the said manipulating portion, and the bending angle of the said bending portion is detected according to the difference in length inside the said manipulating portion between the two wire ropes.

The educational simulator for transesophageal echocardiography according to a sixth embodiment of this patent application is the educational simulator for transesophageal echocardiography defined in the fifth embodiment, wherein the acral portion of the said dummy probe is embedded with a laser diode and a cylindrical lens placed on the front face of the light emitting portion of the said laser diode, and the said manipulating portion is embedded with a servomotor. A laser beam emitted from the said laser diode is diffused to a crossbar shape by the said cylindrical lens, and the said servomotor turns the said cylindrical lens parallel to the light emitting portion of the said laser diode in conjunction with the actuation of the said changeover switch so as to change over the direction of the said crossbar-shaped laser beam continuously.

### BRIEF DESCRIPTION OF THE DRAWINGS

FIG. 1 is a pattern diagram of the educational simulator for transesophageal echocardiography relating to the embodiment.

FIG. 2 is a pattern diagram of the dummy probe used in the embodiment.

FIG. 3 is an enlarged view of the dummy probe used in the embodiment.

FIG. 4 is explanatory drawings of the laser diode, cylindrical lens and laser beam. FIG. 4(a) is a drawing showing the arrangement of the laser diode and cylindrical lens. FIG. 4(b) is a drawing showing the arrangement of the cylindrical lens turned 90° from the position shown in FIG. 4(a) and the relationship between the cylindrical lens and the laser beam.

FIG. 5 is pattern diagrams of the insertion length sensor and rotation angle sensor relating to the embodiment. FIG. 5(a) is a pattern diagram and structural drawing of sensing the insertion length of the dummy probe. FIG. 5(b) is a pattern diagram of sensing the axial rotational direction of the dummy probe inserted.

FIG. 6 is a block diagram of the components of the educational simulator for transesophageal echocardiography relating to the embodiment.

The present invention brings about the following effects with the said configuration:
(1) The dummy probe to be used comprises the acral portion, bending portion, flexural tube portion, and manipulating portion which controls the curving direction of the bending portion, and is patterned after a genuine esophageal ultrasonic probe. The palate, neck and esophagus are formed of flexible materials close to the elasticity of a human body. This enables an operator to obtain a feeling similar to inserting the genuine esophageal ultrasonic probe into the human esophagus and stomach, by inserting the dummy probe into the esophagus and stomach of the human phantom while he controls the curving direction of the bending portion by means of the manipulating knob in the manipulating portion.
(2) Further, if the chassis, palate, neck, esophagus, stomach, blood vessels and heart of the human phantom are formed of transparent or translucent materials, the operator can visually confirm the position of the tip of the dummy probe.
(3) The manipulating portion of the dummy probe is provided with the changeover switch which enables the tomographic direction of the artificial heart to be changed optionally, and the effect similar to changing over the oscillating direction of ultrasonic waves oscillated from the genuine esophageal ultrasonic probe can be confirmed with images to be shown on the display section. Also, the tomographic direction can be confirmed visually with the laser beam emitted from the laser diode embedded in the acral portion of the dummy probe. Meanwhile, the artificial heart stands for the spatial position of a heart which corresponds to the position of the esophagus and stomach in the human phantom.
(4) The sensors to be used are the insertion length sensor, rotation angle sensor, position sensor and bending angle sensor. The insertion length sensor and rotation angle sensor are composed of one pair of optical sensors comprising a light emitting element and a light receiving element. The position sensor comprises a magnet embedded in the acral portion of the dummy probe and magnetic sensors fixed to respective portions of the outside of the esophagus and stomach. The bending angle sensor comprises two wire ropes inserted into the dummy probe. These sensors are relatively compact and simple with little deviation so that the educational simulator for transesophageal echocardiography can be downsized and is excellent in portability and nearly maintenance-free.
(5) It is possible to learn the optimum point of dummy probe scanning and diagnostic technique of pathologic condition from images obtained, since the three-dimensional image archive section holds serial three-dimensional data as time-series dynamic images and the display section shows two-dimensional dynamic images clipped to dummy probe scanning.
(6) The present invention facilitates the readout of predetermined information and the acquisition of the readout technology of two-dimensional images in ultrasonic diagnosis, because of two-dimensional virtual images provided on the same screen, although it is not easy for even an expert to read the predetermined information from two-dimensional images shown on the display section in actual echocardiographic diagnosis.

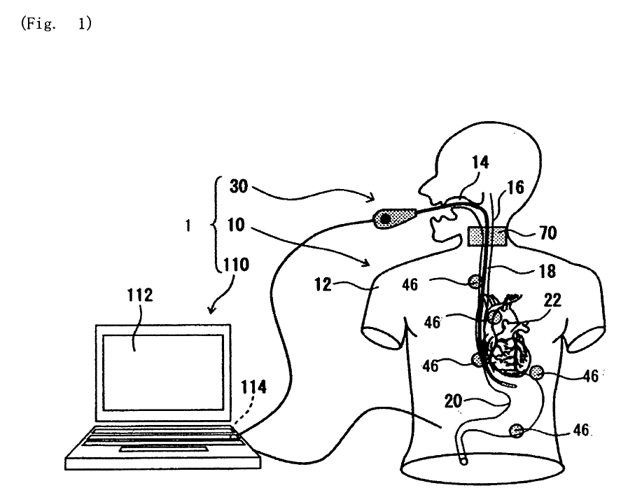

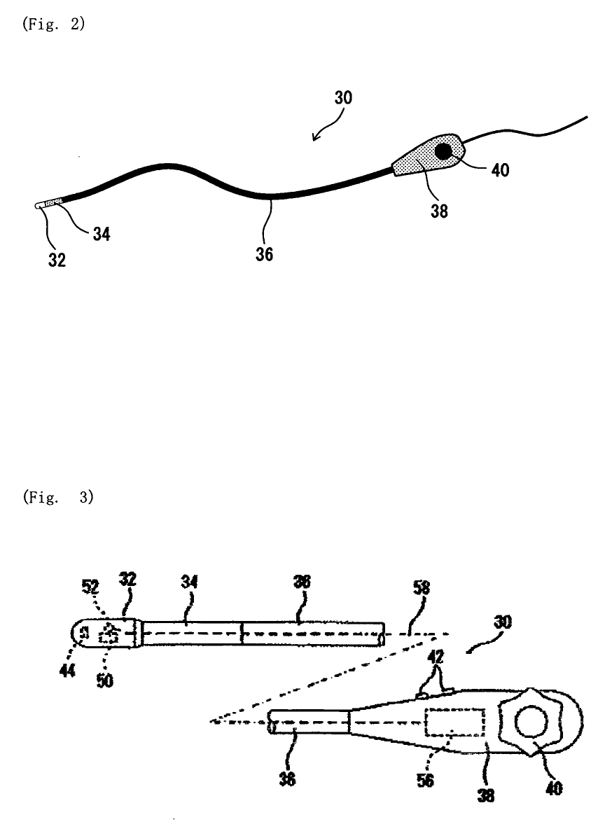

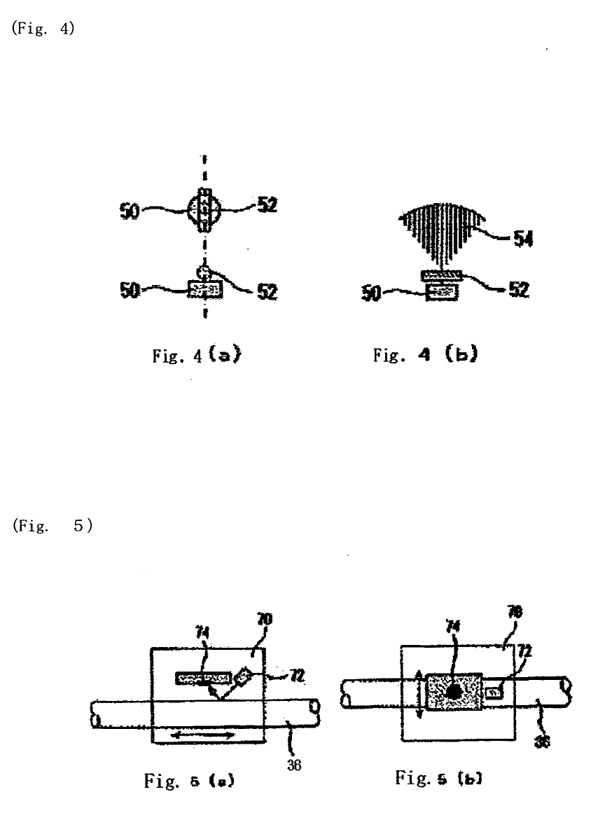

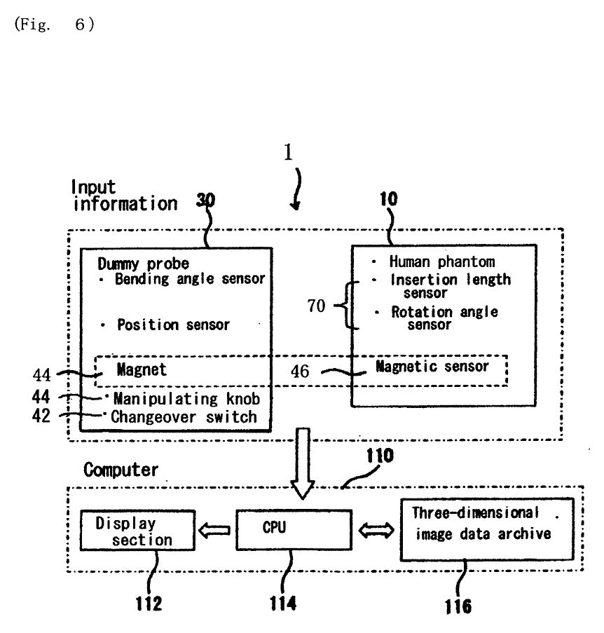

A description is hereinafter made of an embodiment of the present invention in the best feature to carry out the present invention, on the basis of FIG. 1-6. FIG. 1 is a pattern diagram of the educational simulator for transesophageal echocardiography relating to the embodiment. FIG. 2 is a pattern diagram of the dummy probe used in the embodiment. FIG. 3 is an enlarged view of the dummy probe used in the embodiment. FIG. 4 is explanatory drawings of the laser diode, cylindrical lens and laser beam. FIG. 4(a) is a drawing showing the arrangement of the laser diode and cylindrical lens. FIG. 4(b) is a drawing showing the arrangement of the cylindrical lens turned 90° from the position shown in FIG. 4(a) and the relationship between the cylindrical lens and the laser beam. FIG. 5 is pattern diagrams of the insertion length sensor and rotation angle sensor relating to the embodiment. FIG. 5(a) is a pattern diagram and structural drawing of sensing the insertion length of the dummy probe. FIG. 5(b) is a pattern diagram of sensing the axial rotational direction of the dummy probe inserted. FIG. 6 is a block diagram of the components of the educational simulator for transesophageal echocardiography relating to the embodiment.

A description is hereinafter made of the educational simulator for transesophageal echocardiography 1 relating to the embodiment, on the basis of FIG. 1-6.

The educational simulator for transesophageal echocardiography 1 comprises the human phantom 10, the dummy probe 30 and the personal computer 110, in appearance.

The human phantom 10 is composed of the chassis 12 patterned after a human upper body, and the palate 14, neck 16, esophagus 18, stomach 20 and heart 22 which are fixed in the chassis 12. The esophagus 18 and stomach 20 are formed from hollow tubes. The palate 14 is open toward the outside. The neck 16 communicates with the palate 14. The esophagus 18 communicates with the neck 16. The stomach 20 communicates with the esophagus 18.

In the embodiment, the chassis 12, palate 14, neck 16, esophagus 18, stomach 20 and heart 22, except the head, are made of transparent synthetic resin. The palate 14, neck 16, esophagus 18 and stomach 20 are formed of flexible synthetic resin such as silicon resin which is close to the elasticity of a human body. The chassis 12 is split into a front part and a rear part, and the front part is designed to fit into the rear part and to be freely detachable. Coronary vessels are painted on the outside of the heart, and model diverse blood vessels, diaphragms, lungs and ribs are provided.

Further, the insertion length/rotation angle sensor 70 is fixed in the neck 16, and small magnetic sensors 46, 46, . . . are affixed to the outside of the esophagus 18 and stomach 20 at proper intervals.

The dummy probe 30 comprises the hard acral portion 32 having the spherical tip, the bending portion 34 which is free to curve and communicates with the acral portion 32, the flexural tube portion 36 shaped like a flexible and elongated circular tube which communicates with the bending portion 34 and the manipulating portion 38 which is of nearly a rectangular parallelepiped and communicates with the flexural tube portion 36. The shape of the dummy probe 30 and the flexibility of the flexural tube portion 36 are designed to be almost the same as the genuine ultrasonic probe.

The insides of the acral portion 32, bending portion 34, flexural tube portion 36 and manipulating portion 38 communicate with each other, and two wire ropes (unillustrated) for curving the bending portion 34, two wire ropes 58 for changing the direction of the cylindrical lens 52 described below and an electric wire (unillustrated) for supplying electric current to the laser diode 50 described below are inserted into the insides. The two wire ropes for curving the bending portion are connected to the manipulating knob 40.

As shown in FIG. 3, the acral portion 32 is a hollow cylinder and shaped like a closed sheath with a hemispherical tip. The magnet 44 is embedded in the tip of the acral portion 32. Further, in the acral portion 32 toward the bending portion 34 from the magnet 44 the laser diode 50 and cylindrical lens 52 are embedded. The light emitting portion of the laser diode 50 is fixed facing the direction orthogonal to the length of the acral portion 32. The cylindrical lens 52 is mounted on the front of the light emitting portion of the laser diode 50.

The manipulating portion 38 is of nearly a flat rectangular parallelepiped in which the servomotor 56 is placed. The manipulating knob 40 is mounted on the surface of the manipulating portion 38 to be free to turn.

The laser diode 50 is supplied with electric current by means of the electric wire (unillustrated) inserted into the insides of the bending portion 34, flexural tube portion 36 and manipulating portion 38 of the dummy probe 30, and emits laser beams by laser oscillation.

The upper drawing of FIG. 4(a) is a plan view of the arrangement of the laser diode and cylindrical lens, and the lower drawing of FIG. 4(b) is a side view of the arrangement of the laser diode and cylindrical lens. As shown in FIG. 4(a), the cylindrical lens 52 is placed on the front of the light emitting portion of the laser diode 50. As shown in FIG. 4(b), the laser beam 54 emitted from the light emitting portion of the laser diode 50 is designed to diffuse sectorally in a crossbar shape. The direction of the crossbar shape is designed to change as the cylindrical lens 52 turns parallel to the light emitting portion of the laser diode 50.

The cylindrical lens 52 and the servomotor 56 are connected by the wire ropes 58, and further the servomotor 56 is connected with the changeover switch 42. The cylindrical lens 52 is designed to turn continuously from 0° to 180° via the servomotor 56 by manipulating the changeover switch 42.

If the diffusion of the laser beam 54 is made orthogonal to the length of the acral portion 32, this laser beam 54 corresponds to transverse scanning in the genuine ultrasonic diagnosis. If the diffusion of the laser beam 54 is made parallel to the length of the acral portion 32, the laser beam 54 corresponds to longitude scanning in the ultrasonic diagnosis.

The bending portion 34 on the acral portion 32 side and the manipulating knob 40 are connected by the two wire ropes (unillustrated). One of the two wire ropes is strained and the other is loosened so that the bending portion 34 is curved. The bending angle of the bending portion 34 is detected with the difference in length between the two wire ropes at the manipulating portion 38.

A description is hereinafter made of the insertion length/rotation angle sensor 70, mainly on the basis of FIG. 5. The insertion length/rotation angle sensor 70 is placed in the neck 16, and comprises the light emitting element 72 and the light receiving element 74. The light emitting element 72 uses a red laser diode. The light emitted from the light emitting element 72 is reflected on the surface of the flexural tube portion 36, and the reflected light is received by the light receiving element 74. At that time the surface pattern of the flexural tube portion 36 is detected by the light receiving element 74. The insertion length of the dummy probe 30 is detected on a noncontact basis from the travel amount of the flexural tube portion 36 inserted, by following up the said surface pattern, and the travel amount of the dummy probe 30 in the rotational direction is designed to be detected on a noncontact basis.

The position sensor comprises the magnet 44 embedded in the tip of the acral portion 32, and the magnetic sensors 46, 46 . . . fixed to the outside of the esophagus 18 and stomach 20. When the tip of the dummy probe 30 inserted into the esophagus 18 is further thrust in, the tip reaches the inside of the stomach 20. When the tip of the dummy probe 30 goes through the esophagus 18, the magnetic sensor 46 that is nearest to the tip of the dummy probe 30 senses magnetism from the magnet 44 so that the position of the tip of the dummy probe 30 is detected. When the tip of the dummy probe 30 reaches the inside of the stomach 20, the magnetic sensor 46 that is nearest to the tip of the dummy probe 30 senses magnetism from the magnet 44 so that the position of the tip of the dummy probe 30 is detected. It is possible to calculate the position of the tip of the dummy probe 30 from the insertion length and rotation angle of the dummy probe 30 sensed by the insertion length/rotation angle sensor 70, but it is difficult to detect the exact position of the tip of the dummy probe 30 inside the stomach 20 only from the insertion length of the dummy probe 30 because the stomach has a prescribed space, unlike the inside of the esophagus 18. In this case the position sensor functions effectively. The size of the magnet 44 can be minimized since it is a rare earth magnet.

The information on the bending angle of the bending portion 34 by the bending angle sensor, the information on the insertion length and rotation angle of the dummy probe 30 by the insertion length/rotation angle sensor 70 and the information on the position of the tip of the dummy probe 30 by the position sensor is numeric data in which the installation position of the insertion length/rotation angle sensor 70 is the original point of coordinates. Since the information on the position of the heart 22 can also be made definite numeric data with reference to the original point, the numeric data from the said respective sensors can be converted to the ones with the position of the heart 22 as the original point.

The personal computer 110 comprises the display section 112, the CPU 114 and the three-dimensional data archive 116. The three-dimensional image data archive 116 stores three-dimensional echocardiographic real images of healthy subjects, three-dimensional echocardiographic real images of subjects having cardiac diseases, and three-dimensional echocardiographic virtual images as two-dimensional images or outlines made out on the basis of the said three-dimensional echocardiographic real images. The CPU 114 calculates the position and inclination of the acral portion 32 of the dummy probe 30 and the direction of the laser beam emitting portion 56 provided in the acral portion 32 in relation to the heart 22 from the data on the bending angle of the bending portion 34, the data on the insertion length of the dummy probe 30, the data on the rotation angle of the dummy probe 30, the data on the position of the tip of the dummy probe 30 and the data on the definite position of the heart 22, and further calculates the position, direction, inclination and scope of the tomographic view of three-dimensional images pointed out by the dummy probe 30, on the basis of the results of the said calculation and the tomographic directional information on the heart 20 transmitted from the changeover switch 42 in the manipulating portion, and clips the tomographic image data out of the three-dimensional image data of the three-dimensional echocardiographic real images and three-dimensional echocardiographic virtual images stored in the three-dimensional image data archive 116. The display section 112 shows the clipped tomographic image data as two-dimensional images.

The said echocardiographic real images stored in the three-dimensional image data archive 116 are three-dimensional real images. These images are three-dimensional dynamic images recorded on one or some beats of the heart since the actual heart always pulsates, and are three-dimensional real images carrying a time axis. The echocardiographic images shown on the display section 112 are two-dimensional images which are time-series two-dimensional dynamic images carrying a time axis.

A description is hereinafter made of a feature of using the educational simulator for transesophageal echocardiography 1 relating to the embodiment.
(1) The acral portion 32 of the dummy probe 30 is inserted from the palate 14 and is further thrust into the insertion length/rotation angle sensor 70 in the neck 16. (step 1) Attention needs to be paid so that the direction of the laser beam emitting portion 56 does not change in inserting the dummy probe 30.
(2) The dummy probe 30 is inserted further while the flexural tube portion 36 is grasped. (step 2) When the data on the insertion length of the dummy probe 30 detected by the insertion length/rotation angle sensor 70 exceed the prescribed value or when the magnetic sensor 46 affixed to the outside of the esophagus 18 senses magnetism from the magnet 44, the CPU 114 works to clip the tomographic image data on the basis of the data from the respective sensors and makes the display section 112 show the clipped tomographic image data as two-dimensional images. The position and direction of the tomogram by the CPU 114 from the three-dimensional image data can be checked visually with the laser beam 54 because the chassis 12 and esophagus 18 are transparent.
(3) The dummy probe 30 is turned at a proper position inside the esophagus 18 or the bending angle of the bending portion 34 is changed by turning the manipulating knob 40, while the dummy probe 30 is being inserted, and a comparison is made between the direction of the laser beam 54 from the laser beam emitting portion 56 and the two-dimensional images shown by the display section 112. (step 3)
(4) As the dummy probe 30 is further thrust, the tip of the dummy probe 30 reaches the stomach 18. At this position, too the act described in step 3 is repeated. (step 4)

The said steps 1-4 enable the manipulating way of the dummy probe 30 to be learned. The above description is an example of using the educational simulator for transesophageal echocardiography 1 relating to the embodiment.

1. An educational simulator for transesophageal echocardiography comprising:
a human phantom in a chassis patterned after a human upper body wherein a neck communicating with the outside through a palate, an esophagus communicating with the neck and a stomach communicating with the esophagus are fixed at prescribed positions;
a dummy probe patterned after a genuine esophageal ultrasonic probe and comprising a sheath-shaped acral portion having a nearly spherical tip, a bending portion which is free to curve and communicates with the acral portion, a flexural tube portion which is flexible and communicates with the bending portion, and a manipulating portion which communicates with the flexural tube portion and is provided with a changeover switch for changing over the tomographic direction of an artificial heart together with a manipulating knob for controlling the curving direction of the bending portion;
an insertion length sensor which is placed in the said neck and detects the insertion length from the neck of the said dummy probe inserted into the said esophagus, and a rotation angle sensor which detects the rotation angle of the said flexural tube portion in the neck;
a position sensor which detects the position of the tip of the said dummy probe;
a bending angle sensor which detects the bending angle of the said bending portion;
a three-dimensional image data archive which stores transesophageal echocardiographic three-dimensional image data;
a CPU which calculates the position and inclination of the acral portion of the said dummy probe in relation to the artificial heart in the said human phantom from the information on the said insertion length, the information on the said rotation angle, the information on the said position of the tip and the information on the said bending angle and which clips tomographic image data out of the said three-dimensional image data, after calculating the position, inclination and direction of the tomographic view of the said three-dimensional image data from the results of the said calculation and the tomographic directional information on the said artificial heart; and
a display section which shows the said clipped tomographic image data as two-dimensional images.

2. The educational simulator for transesophageal echocardiography as defined in claim 1, wherein the said echocardiographic three-dimensional image data are echocardiographic three-dimensional real image data and/or echocardiographic three-dimensional virtual image data, and the said two-dimensional images shown on the said display section are two-dimensional images on the basis of the said three-dimensional real image data and/or the said three-dimensional virtual image data, or three-dimensional image data in which the three-dimensional real image data and the three-dimensional virtual image data are superimposed, and the said display section shows the heart as if it pulsates continuously, by repeatedly showing time-series data on one or several beats of the heart.

3. The educational simulator for transesophageal echocardiography as defined in claim 1, wherein the said human phantom is equipped with a heart which is fixed to a prescribed position in the said chassis, and the said chassis, said palate, said neck, said esophagus, said stomach and said heart connecting with diverse blood vessels are formed of transparent or translucent materials.

4. The educational simulator for transesophageal echocardiography as defined in claim 3, wherein the said palate, said neck and said esophagus are formed of flexible materials.

5. The educational simulator for transesophageal echocardiography as defined in claim 1, wherein the said insertion length sensor and said rotation angle sensor comprise a light emitting element, and a light receiving element which receives the reflected light on the surface of the said dummy probe of the light emitted from the said light emitting element, and the insertion length and rotation angle of the said artificial probe are detected according to variation in the pattern of the surface of the said dummy probe sensed by the said light receiving element, and wherein the said position sensor comprises a magnet embedded in the said acral portion and magnetic sensors fixed to the respective parts on the outside of the said esophagus and said stomach, and the position of the tip of the said acral portion is detected by the magnetic sensors sensing magnetism of the said magnet, and wherein the said bending angle sensor comprises two wire ropes inserted into the said dummy probe, with one end of the said wire ropes fixed to the tip of the said bending portion and with the other end of the said wire ropes extended to the inside of the said manipulating portion, and the bending angle of the said bending portion is detected according to the difference in length inside the said manipulating portion between the two wire ropes.

6. The educational simulator for transesophageal echocardiography as defined in claim 5, wherein the acral portion of the said dummy probe is embedded with a laser diode and a cylindrical lens placed on the front face of the light emitting portion of the laser diode, and the said manipulating portion is embedded with a servomotor so that a laser beam emitted from the said laser diode is diffused to a crossbar shape by the said cylindrical lens, and the said servomotor turns the said cylindrical lens parallel to the light emitting portion of the said laser diode in conjunction with the actuation of the said changeover switch so as to change over the direction of the said crossbar-shaped laser beam continuously.
